(19) United States
(12) Patent Application Publication
(10) Pub. No.: US 2017/0305118 A1
(43) Pub. Date: Oct. 26, 2017

(54) FILM, DECORATED MOLDING ARTICLE AND METHOD FOR FABRICATING DECORATED MOLDING ARTICLE

(71) Applicant: Jin Ya Dian Technology Co.,Ltd., Taoyuan City (TW)

(72) Inventors: Kuo-Liang Ying, Taoyuan City (TW); Ya-Yu Lai, New Taipei City (TW)

(73) Assignee: Jin Ya Dian Technology Co.,Ltd., Taoyuan City (TW)

(21) Appl. No.: 15/216,699

(22) Filed: Jul. 22, 2016

(30) Foreign Application Priority Data
Apr. 20, 2016 (TW) 105112253

(51) Int. Cl. B32B 21/14; B32B 5/02; B29C 45/14; B32B 7/12; B32B 27/06

(52) U.S. Cl. CPC B32B 21/14; B32B 7/12; B32B 27/06; B29C 45/14688; B32B 5/022; B32B 2451/00

(57) ABSTRACT

A film for decorating a workpiece, a decorated molding article and a method for fabricating the decorated molding article are provided. The film includes a wood veneer layer, an extension layer, an adhesive layer, and a base layer. The wood veneer layer has a first surface and a second surface opposite to each other. The extension layer is disposed on the first surface of the wood veneer layer. The adhesive layer is disposed on the second surface of the wood veneer layer. The base layer is disposed between the wood veneer layer and the adhesive layer. The adhesive layer is disposed between the base layer and the workpiece.

### CROSS-REFERENCE TO RELATED APPLICATION

This application claims the priority benefit of Taiwan application serial no. 105112253, filed on Apr. 20, 2016. The entirety of the above-mentioned patent application is hereby incorporated by reference herein and made a part of this specification.

### BACKGROUND OF THE INVENTION

### Field of the Invention

The invention relates to a film, a decorated molding article and a method for fabricating the decorated molding article, and particularly relates to a film for decorating a workpiece, a decorated molding article and a method for fabricating the decorated molding article.

### Description of Related Art

In general, patterns or texts formed on a casing surface of an object are mainly formed by a spraying or printing process, so as to present a specific visual effect, and add variability of appearance of the object. However, since the spraying process has disadvantages, such as time consumption, complicated process, and low thickness uniformity, it is not suitable for application in large scale production. To solve the above problems, a variety of specific decoration processes using decorative films are proposed. For example, in-mold decoration (IMD), or out mold decoration (OMD) has become another choice to form the patterns or texts on the surface of the object.

In particular, the in-mold decoration is mainly that, a transfer film printed with patterns is placed in a mold, such as an injection molding machine, and then a resin is injected into the mold, so that the resin and the transfer film are combined with each other. After the resin is cooled, a decorated molding article is taken out from the mold to complete the in-mold decoration process. The out mold decoration is the use of high pressure vacuum transfer method that an outer surface of the workpiece is directly covered by a transparent film printed with patterns or texts, or a pattern layer. The decorated molding article formed by the out mold decoration has characteristics of covering bending angle, which can be widely decorated in a variety of shell materials. Also, it can further improve the application of product appearance decoration.

### SUMMARY OF THE INVENTION

The invention provides a film for decorating a workpiece, a decorated molding article and a method for fabricating the decorated molding article, which is capable of decorating a wood veneer on the workpiece directly by the in-mold decoration or the out mold decoration, so as to effectively simplify the process and reduce the cost.

The invention provides a film for decorating a workpiece, a decorated molding article and a method for fabricating the decorated molding article, which can provide users with a smooth tactile effect and a high gloss visual effect.

The invention provides a film for decorating a workpiece. The film includes a wood veneer layer, an extension layer, an adhesive layer, and a base layer. The wood veneer layer has a first surface and a second surface opposite to each other. The extension layer is disposed on the first surface of the wood veneer layer. The adhesive layer is disposed on the second surface of the wood veneer layer. The base layer is disposed between the wood veneer layer and the adhesive layer. The adhesive layer is disposed between the base layer and the workpiece.

According to an embodiment of the invention, a material of the extension layer includes an ultraviolet hardening resin or a thermal curing resin, such that a degree of elongation and a tensile strength of the extension layer are more than a degree of elongation and a tensile strength of the wood veneer layer.

According to an embodiment of the invention, a material of the extension layer is a transparent material. The transparent material allows a viewer to see the first surface of the wood veneer layer below the extension layer by penetrating the extension layer.

According to an embodiment of the invention, the first surface and the second surface of the wood veneer layer are both uneven surfaces.

According to an embodiment of the invention, the extension layer conformally covers on the first surface of the wood veneer layer.

According to an embodiment of the invention, the base layer is a non-woven fabric layer. The non-woven fabric layer fills the second surface of the wood veneer layer to improve a flatness of the second surface.

According to an embodiment of the invention, the adhesive layer includes a hot melt adhesive, a UV hardening adhesive, a light hardening adhesive, an electron hardening adhesive, or a combination thereof. A material of the adhesive layer is at least one selected from the group consisting of polyacrylate, polymethacrylate, polystyrene, polycarbonate, polyurethane, polyester, polyamide, epoxy resin, ethylene vinylacetate copolymer, and thermoplastic elastomer.

According to an embodiment of the invention, the film further includes a pattern layer disposed on the extension layer, such that the extension layer is located between the pattern layer and the wood veneer layer.

The invention further provides a film for decorating a workpiece. The film includes a wood veneer layer, an adhesive layer, and a base layer. The wood veneer layer has a first surface and a second surface opposite to each other. The adhesive layer is disposed on the second surface of the wood veneer layer. The base layer is disposed between the wood veneer layer and the adhesive layer. The adhesive layer is disposed between the base layer and the workpiece.

The invention provides a decorated molding article including a workpiece and the film. The workpiece has an outer surface. The film is disposed on the outer surface of the workpiece, wherein the film is attached on the workpiece by the adhesive layer.

According to an embodiment of the invention, a material of the outer surface of the workpiece includes a plastic, metal, a carbon fiber, glass, or a combination thereof.

The invention provides a method for fabricating a decorated molding article including the following steps. The film is provided. An in-mold decoration or an out mold decoration is performed on the film, such that the film is attached on the outer surface of the workpiece by the adhesive layer.

According to an embodiment of the invention, the steps of performing the in mold decoration on the film are as follows. The film is disposed in an in-mold decoration mold having a mold cavity, wherein the film covers at least a portion of a surface of the mold cavity. A molding material is injected into the in-mold decoration mold, such that the molding material and the film are combined with each other. The molding material is cooled. The decorated molding article is taken out from the in-mold decoration mold.

According to an embodiment of the invention, the steps of performing the out mold decoration on the film are as follows. A workpiece is provided. The workpiece and the film are placed in a fixture. A high pressure decorative molding process is performed, such that the film is attached on the outer surface of the workpiece by the adhesive layer.

According to an embodiment of the invention, the steps of the high pressure decorative molding process are as follows. A heating and softening step is performed on the film. The film is contacted with the workpiece, and a pressing step is performed. A high pressure vacuum molding step is performed on the film and the workpiece, such that the film is attached on the outer surface of the workpiece.

According to an embodiment of the invention, a temperature of the heating and softening step is between 50° C. and 180° C.

According to an embodiment of the invention, a time of the heating and softening step is between 1 second and 300 seconds.

According to an embodiment of the invention, a method for forming the film is as follows. A wood veneer layer is provided. The wood veneer layer has a first surface and a second surface opposite to each other. A base layer is formed on the second surface of the wood veneer layer. An adhesive layer is formed on the base layer, such that the base layer is disposed between the wood veneer layer and the adhesive layer.

According to an embodiment of the invention, a method for forming the film further includes forming an extension layer on the first surface of the wood veneer layer. A method for forming the extension layer includes forming a resin material layer on the first surface of the wood veneer layer by a roll coating method, a spraying method, a printing method, or a coating method.

According to an embodiment of the invention, a method for forming the film further includes forming a pattern layer on the extension layer, such that the extension layer is located between the pattern layer and the wood veneer layer.

Based on the above, the film with the wood veneer layer of the embodiment can be directly decorated on the workpiece by the in-mold decoration or the out mold decoration. Compared to the conventional way that cutting the whole wood to achieve the decoration of the original wood veneer, the invention can effectively simplify the process and reduce the cost. Moreover, the decorated molding article of the invention can provide the users with the smooth tactile effect and the high gloss visual effect at the same time, thereby generating a wood veneer decorating effect different from the previous decorated molding article.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a film according to a first embodiment of the invention.

FIG. 2 is a schematic cross-sectional view of a film according to a second embodiment of the invention.

FIG. 3 is a schematic cross-sectional view of a film according to a third embodiment of the invention.

FIG. 4 is a schematic cross-sectional view of a decorated molding article according to a fourth embodiment of the invention.

FIG. 5 is a schematic cross-sectional view of a decorated molding article according to a fifth embodiment of the invention.

FIG. 6 is a schematic cross-sectional view of a decorated molding article according to a sixth embodiment of the invention.

FIG. 7 is a step flow chart of a method for fabricating the film according to the first embodiment of the invention.

FIG. 8 is a step flow chart of a method for fabricating the film according to the second embodiment of the invention.

FIG. 9 is a step flow chart of a method for fabricating the film according to the third embodiment of the invention.

FIG. 10 is a step flow chart of a method for fabricating a decorated molding article according to a seventh embodiment of the invention.

FIG. 11 is a step flow chart of a method for fabricating a decorated molding article according to an eighth embodiment of the invention.

### DESCRIPTION OF THE EMBODIMENTS

Hereinafter, the invention is illustrated more comprehensively referring to the drawings. However, the invention may be embodied in many different forms and should not be construed as limited to the embodiments set forth herein. The directional terminology mentioned in the following embodiments, such as “top,” “bottom,” etc., is used with reference to the orientation of the drawings being described. As such, the directional terminology is used for purposes of illustration and is in no way limiting. Thicknesses of layers and regions in the drawings may be enlarged for clarity. The same or similar reference numbers represent the same or similar components, and are not repeated again in the following paragraphs.

First, films of the first embodiment, the second embodiment, and the third embodiment of the invention are described. All the above three can be used to decorate a workpiece, so as to increase a tactile effect and a visual effect of a user or a viewer.

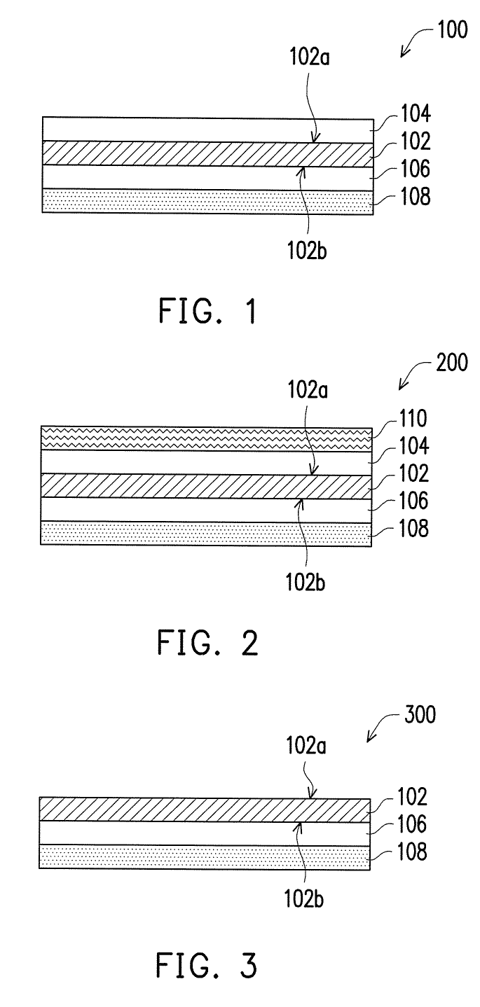

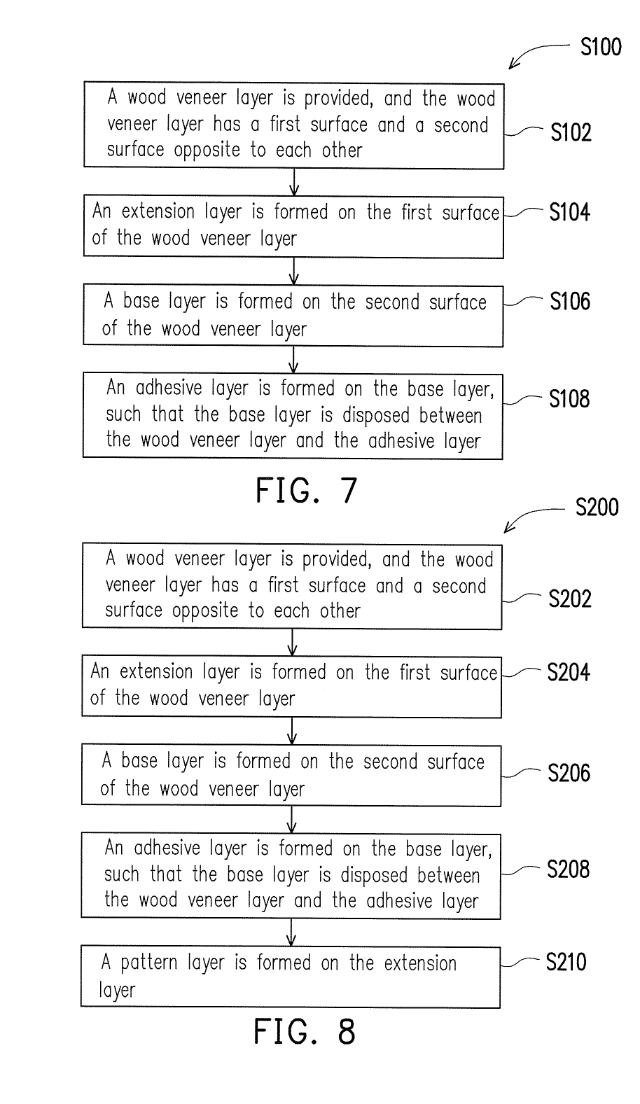

FIG. 1 is a schematic cross-sectional view of a film according to a first embodiment of the invention. FIG. 7 is a step flow chart of a method for fabricating the film according to the first embodiment of the invention.

Referring to FIG. 1 and FIG. 7, a step process S100 of a method for fabricating a film 100 of the first embodiment is as follows. A step S102 is performed. A wood veneer layer 102 is provided. The wood veneer layer 102 has a first surface 102a and a second surface 102b opposite to each other. In an embodiment, a specie of the wood veneer layer 102 may be an ebony, a walnut, a maple, a cherry wood, a rosewood, a mahogany, a white oak, a teakwood, a flower camphor, a cypress, an ochrosiacoccinea, or a combination thereof, for example. However, the invention is not limited thereto. The specie of the wood veneer layer 102 may be adjusted according to the needs of users. Additionally, FIG. 1 shows that the first surface 102a is located on the second surface 102b; however, the invention is not limited thereto. In other embodiments, the first surface 102a may be located below the second surface 102b.

Thereafter, a step S104 is performed. An extension layer 104 is formed on the first surface 102a of the wood veneer layer 102. In particular, a resin material layer (not shown) may be formed on the first surface 102a of the wood veneer layer 102 by a roll coating method, a spraying method, a printing method, or a coating method. Then, the resin material layer is irradiated with ultraviolet light or heated to be cured or be hardened, so as to form the extension layer 104. In an embodiment, a material of the resin material layer may be, for example, an ultraviolet hardening resin or a thermal curing resin. For instance, the material of the resin material layer may be a resin material, such as acrylic resin, polyurethane (PU), epoxy resin, or a combination thereof. The above material is able to enhance a degree of elongation and a tensile strength of the formed extension layer 104 which may be more than a degree of elongation and a tensile strength of the wood veneer layer 102. Thus, the extension layer 104 can effectively improve the degree of elongation and the tensile strength of the wood veneer layer 102, so that the wood veneer layer 102 is not easy to be broken during heating or compression molding process performed on the wood veneer layer 102 subsequently.

In another embodiment, a material of the extension layer 104 may be a transparent material, for example. The transparent material may allow a viewer to see the first surface 102a of the wood veneer layer 102 below the extension layer 104 by penetrating the extension layer 104. That is, the viewer can see the wood veneer texture of the first surface 102a of the wood veneer layer 102. Additionally, since the first surface 102a and the second surface 102b of the wood veneer layer 102 have uneven three-dimensional wood veneer surfaces, and a thickness of the extension layer 104 is less than the roughness of the first surface 102a, the extension layer 104 can conformally covers the first surface 102a of the wood veneer layer 102. Therefore, the viewer not only can see the three-dimensional texture of the wood veneer layer 102, but also can sense the smooth and soft tactile effects and the high gloss visual effect of the extension layer 104. In other words, for the user or the viewer, the film 100 of the embodiment can provide the smooth tactile effect and the three-dimensional visual effect at the same time. However, the invention is not limited thereto. In other embodiments, the extension layer 104 can be formed by a highlight method or an extinction method, so that the formed extension layer 104 can have a high gloss visual effect or an extinction visual effect.

Then, a step S106 is performed. A base layer 106 is formed on the second surface 102b of the wood veneer layer 102 by a fabric imprinting lamination method. In an embodiment, the base layer 106 may be a non-woven fabric layer, for example. Since the second surface 102b of the wood veneer layer 102 also has an uneven three-dimensional wood veneer surface, the non-woven fabric layer can fill in a concave surface of the second surface 102b of the wood veneer layer 102 (namely the surface which is recessed from the second surface 102b toward the first surface 102a), so as to improve the flatness of the second surface 102b. That is, the surface of the non-woven fabric layer after filling is flatter than the original uneven surface of the second surface 102b. Therefore, the non-woven fabric layer not only can assist extension of the wood veneer layer 102, but also can increase the adhesion of an adhesive layer 108 subsequently formed.

Then, a step S108 is performed. The adhesive layer 108 is formed on the base layer 106, such that the base layer 106 is disposed between the wood veneer layer 102 and the adhesive layer 108. In an embodiment, the adhesive layer 108 may be a hot melt adhesive, a UV hardening adhesive, a light hardening adhesive, an electron hardening adhesive, or a combination thereof, for example. For instance, a material of the adhesive layer 108 may be at least one material selected from polyacrylate, polymethacrylate, polystyrene, polycarbonate, polyurethane, polyester, polyimide, epoxy resin, ethylene vinylacetate copolymer (EVA), thermoplastic elastomer, or a copolymer, a mixture, or a composite of the above materials.

Incidentally, the order of the step S104 and the step S106 can be adjusted according to the needs. That is, after the extension layer 104 is formed on the first surface 102a of the wood veneer layer 102 (i.e., the step S104), the base layer 106 is formed on the second surface 102b of the wood veneer layer 102 (i.e., the step S106); however, the invention is not limited thereto. In other embodiments, the step S106 is performed first, and then the step S104 is performed.

Based on the above, the film 100 fabricated by the method for fabricating the film 100 of the first embodiment includes the wood veneer layer 102, the extension layer 104, the adhesive layer 108, and the base layer 106. The wood veneer layer 102 has the first surface 102a and the second surface 102b opposite to each other. The extension layer 104 is disposed on the first surface 102a of the wood veneer layer 102. The adhesive layer 108 is disposed on the second surface 102b of the wood veneer layer 102. The base layer 106 is disposed between the wood veneer layer 102 and the adhesive layer 108. In an embodiment, the extension layer 104 may be in contact with the first surface 102a of the wood veneer layer 102 directly; and the base layer 106 may be in contact with the second surface 102b of the wood veneer layer 102 directly.

FIG. 2 is a schematic cross-sectional view of a film according to a second embodiment of the invention. FIG. 8 is a step flow chart of a method for fabricating the film according to the second embodiment of the invention.

Referring to FIG. 1, FIG. 2, FIG. 7, and FIG. 8, a step process S200 of a film 200 of the second embodiment of the invention is substantially similar to the step process S100 of the film 100 of the first embodiment of the invention (i.e., the step S102 is similar to a step S202, the step S104 is similar to a step S204, the step S106 is similar to a step S206, and the step S108 is similar to a step S208). The steps S202, S204, S206, and S208 have been described in the above paragraphs, and will not be described in detail. The difference between the two is that, the step process S200 of the film 200 of the second embodiment further includes performing a step S210. A pattern layer 110 is formed on the extension layer 104, such that the extension layer 104 is located between the pattern layer 110 and the wood veneer layer 102. In particular, the pattern layer 110 may be composed of printing inks or printable materials, such as a single layer ink layer, a multilayer ink layer, or a patterned ink layer, so as to present single color, multicolor, or desired patterns respectively. The pattern layer 110 may be formed by any appropriate printing process (e.g., a gravure printing process, a screen printing process, a flexographic printing process, an offset printing process, a reverse printing process, or an ink jet printing process), so as to transfer the ink on the extension layer 104 to form the pattern layer 110. The pattern layer 110 can increase the diversity of patterns and colors of the film 200, so as to enrich the visual effect of the user or the viewer. In an embodiment, a material of the pattern layer 110 may be polyurethane (PU), or polyacrylate mixed with inorganic materials, for example.

Incidentally, the order of the step S210 and the step S208 can be adjusted according to the needs. That is, after the adhesive layer 108 is formed on the base layer 106 (i.e., the step S208), the pattern layer 110 is formed on the extension layer 104 (i.e., the step S210); however, the invention is not limited thereto. In other embodiments, the step S210 is performed first, and then the step S208 is performed.

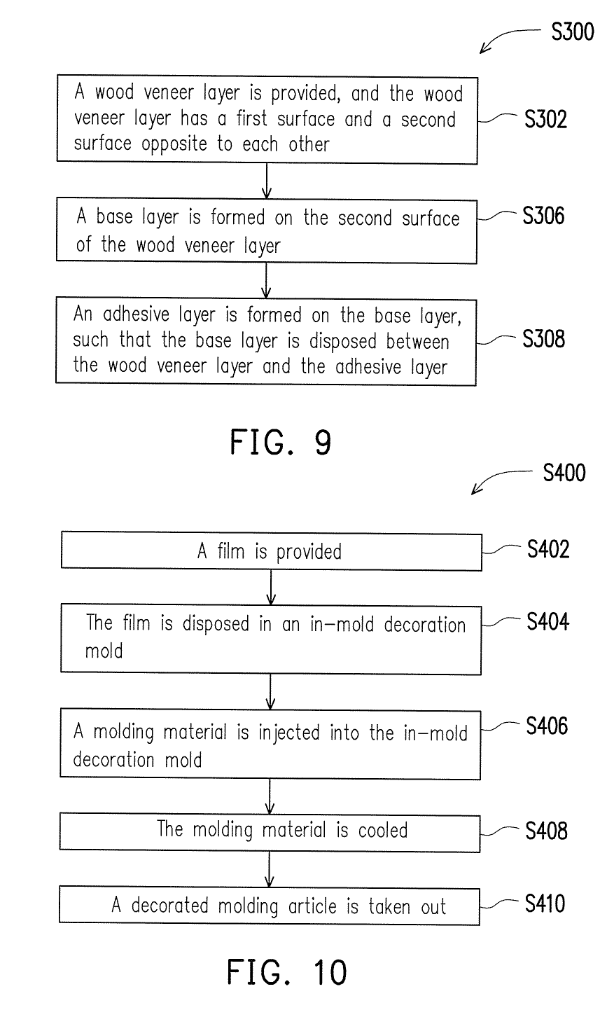

FIG. 3 is a schematic cross-sectional view of a film according to a third embodiment of the invention. FIG. 9 is a step flow chart of a method for fabricating the film according to the third embodiment of the invention.

Referring to FIG. 1, FIG. 3, FIG. 7, and FIG. 9, a step process S300 of a film 300 of the third embodiment of the invention is substantially similar to the step process S100 of the film 100 of the first embodiment of the invention (i.e., the step S102 is similar to a step S302, the step S106 is similar to a step S306, and the step S108 is similar to a step S308). The steps S302, S306, and S308 have been described in the above paragraphs, and will not be described in detail. The difference between the two is that, in the step process S300 of the film 300 of the third embodiment, the extension layer 104 is not formed. That is, the film 300 of the third embodiment only includes the three-layer structure composed of the adhesive layer 108, the base layer 106, and the wood veneer layer 102 stacked in order. The film 300 of the third embodiment can maintain the texture of the wood veneer and reduce the manufacturing cost, so as to increase the advantages on commercial products. Additionally, the film 300 of the third embodiment is suitable for decorating the surface of the general product with a flat surface.

Hereinafter, the film of the above embodiments in the practical application of the decorated molding article and the method of fabricating the same will continue to be described. Below, the decorated molding article and the method of fabricating the same are described by the way of the flow chart with the cross-sectional view of the decorated molding article.

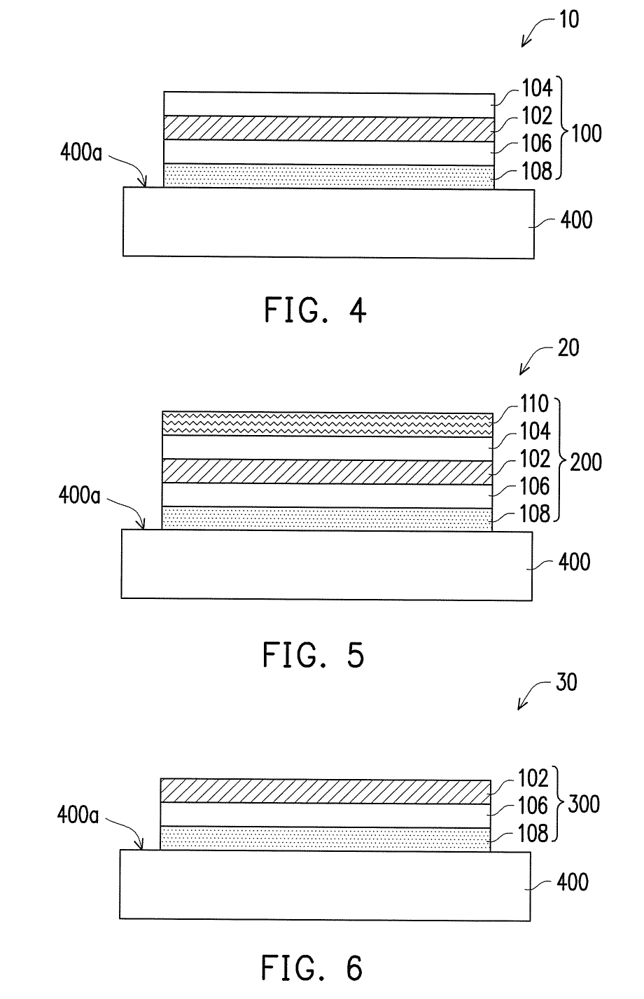

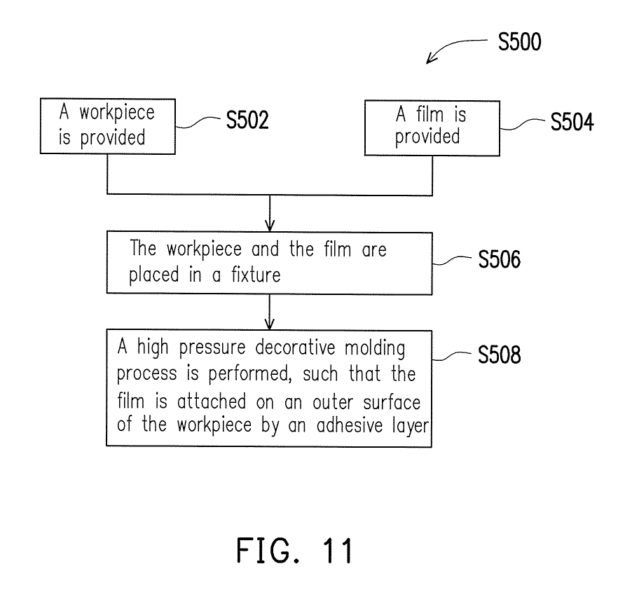

FIG. 4 is a schematic cross-sectional view of a decorated molding article according to a fourth embodiment of the invention. FIG. 5 is a schematic cross-sectional view of a decorated molding article according to a fifth embodiment of the invention. FIG. 6 is a schematic cross-sectional view of a decorated molding article according to a sixth embodiment of the invention. FIG. 10 is a step flow chart of a method for fabricating a decorated molding article according to a seventh embodiment of the invention. FIG. 11 is a step flow chart of a method for fabricating a decorated molding article according to an eighth embodiment of the invention.

Referring to FIG. 4 to FIG. 5 first, FIG. 4 shows that the film 100 is disposed on a workpiece 400 to form a decorated molding article 10 of the fourth embodiment; FIG. 5 shows that the film 200 is disposed on the workpiece 400 to form a decorated molding article 20 of the fifth embodiment; and FIG. 6 shows that the film 300 is disposed on the workpiece 400 to form a decorated molding article 30 of the sixth embodiment. All of the three types of the decorated molding articles 10, 20, and 30 can be fabricated by the fabricating method of FIG. 10 (may be the in-mold decoration, for example) or the fabricating method of FIG. 11 (may be the out mold decoration, for example).

Referring to FIG. 10, a step process S400 of the method for fabricating the decorated molding article of the seventh embodiment is as follows. First, a step S402 is performed. The film is provided. The film may be any one of the films 100, 200, and 300 (hereinafter referred to as the films 100, 200, and 300) as shown in FIG. 1, FIG. 2, and FIG. 3, for example. The composition of the films 100, 200, and 300 has been described in the above paragraphs, and will not be described in detail.

Next, a step S404 is performed. The films 100, 200, and 300 are disposed in an in-mold decoration mold. Specifically, the in-mold decoration mold includes a hollow mold cavity. The mold cavity has a surface. Thereafter, the films 100, 200, and 300 are attached on the surface of the mold cavity, such that the films 100, 200, and 300 cover at least a portion of the surface of the mold cavity.

Then, a step S406 is performed. A molding material is injected into the mold cavity of the in-mold decoration mold, such that the molding material and the films 100, 200, and 300 are combined with each other. In an embodiment, the molding material may be a plastic material, for example.

After that, a step S408 is performed. The molding material is cooled to form the workpiece 400. The workpiece 400 is determined by the application of the decorated molding article of the invention, which can be a casing or component of an electronic device, a casing or component of a vehicle, or a combination thereof. However, the shape and the structure of the workpiece 400 are not limited to the invention. As long as the shape and the structure of the workpiece 400 which can be completed by the in-mold decoration, it is in the scope of the invention.

Then, a step S410 is performed. The decorated molding articles 10, 20, and 30 are taken out from the in-mold decoration mold. At this time, the decorated molding articles 10, 20, and 30 formed as shown in FIG. 4 to FIG. 6 include the films 100, 200, and 300, and the workpiece 400. The films 100, 200, and 300 are attached on a portion of an outer surface 400a of the workpiece 400 respectively by the adhesive layer 108. The portion of the outer surface 400a covered by the films 100, 200, and 300 may be the region to be decorated of the formed decorated molding articles 10, 20, and 30, for example.

On the other hand, the decorated molding articles 10, 20, and 30 may also be fabricated by the out mold decoration. Referring to FIG. 11, the step process 5500 of the method for fabricating the decorated molding article of the eighth embodiment is as follows. First, a step S502 is performed. The workpiece 400 is provided. The workpiece 400 is determined by the application of the decorated molding article of the invention, which can be a casing or component of an electronic device, a casing or component of a vehicle, or a combination thereof. For instance, the workpiece 400 may be a mobile phone, a digital camera, a personal digital assistant (PDA), a laptop computer, a desktop computer, a touch panel, a television, a globe position system (GPS) device, an event data recorder, a navigation, a display, a digital photo frame, a DVD player, an automotive interior decorative board, an automobile dashboard, a clock, a radio, a toy, a watch, or other casing or component used by electronic products which need electric power. In an embodiment, a material of the outer surface 400a of the workpiece 400 may be a plastic, metal, a carbon fiber, glass, or any other casing material that has been formed (e.g., the workpiece fabricated through an appropriate pre-treatment process having the desired characteristics). For instance, when the material of the workpiece is a plastic, a plastic workpiece (i.e., a plastic casing) can be obtained by an injection molding mold after the injection molding process; when the material of the workpiece is metal, a metal workpiece (i.e., a metal casing) can be obtained by performing a surface treatment on the metal.

Then, a step S504 is performed. The film is provided. The film may be any one of the films 100, 200, and 300 (hereinafter referred to as the films 100, 200, and 300) as shown in FIG. 1 to FIG. 3. The composition of the films 100, 200, and 300 has been described in the above paragraphs, and will not be described in detail.

After that, a step S506 is performed. The workpiece 400 and the films 100, 200, and 300 are placed in a fixture. It should be noted that, before performing the step S506, the fixture can be designed according to the needs of the final product selectively, and then the fixture preparation is performed.

Then, a step S508 is performed. A high pressure decorative molding process is performed, such that the films 100, 200, and 300 are attached on the outer surface 400a of the workpiece 400 by the adhesive layer 108. Specifically, the high pressure decorative molding process is that, performing a heating and softening step on the films 100, 200, and 300, for example. In an embodiment, the temperature of the heating and softening step may be between 50° C. and 180° C.; and the time of the heating and softening step may be between 1 second and 300 seconds. Then, the films 100, 200, and 300 are contacted with the workpiece 400, and a pressing step is performed. Thereafter, a high pressure vacuum molding step is performed on the films 100, 200, and 300 and the workpiece 400, such that the films 100, 200, and 300 are transferred onto the workpiece 400. Finally, the rest of the films can be removed by the method of knife cutting, laser cutting, or water jet cutting. In short, the films 100, 200, and 300 of the embodiment can be closely adhered onto the portion of the outer surface 400a of the workpiece 400 by the out mold decoration.

In summary, the film with the wood veneer layer of the invention can be directly decorated on the workpiece by the in-mold decoration or the out mold decoration. Compared to the conventional way that cutting the whole wood to achieve the decoration of the original wood veneer, the invention can effectively simplify the process and reduce the cost. Additionally, the extension layer and the base layer of the invention can effectively improve the degree of elongation and the tensile strength of the wood veneer layer, such that the wood veneer layer is not easy to be broken during heating or compression molding process performed on the wood veneer layer subsequently. Moreover, by the extension layer, the decorated molding article of the invention can provide the users with the smooth tactile effect and the high gloss visual effect at the same time, thereby generating a wood veneer decorating effect different from the conventional decorated molding article.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A film for decorating a workpiece, comprising:
a wood veneer layer, having a first surface and a second surface opposite to each other;
an extension layer, disposed on the first surface of the wood veneer layer;
an adhesive layer, disposed on the second surface of the wood veneer layer; and
a base layer, disposed between the wood veneer layer and the adhesive layer, wherein the adhesive layer is disposed between the base layer and the workpiece.

2. The film according to claim 1, wherein a material of the extension layer comprises an ultraviolet hardening resin or a thermal curing resin, such that a degree of elongation and a tensile strength of the extension layer are more than a degree of elongation and a tensile strength of the wood veneer layer.

3. The film according to claim 1, wherein a material of the extension layer is a transparent material, and the transparent material allows a viewer to see the first surface of the wood veneer layer below the extension layer by penetrating the extension layer.

4. The film according to claim 1, wherein the first surface and the second surface of the wood veneer layer are both uneven surfaces.

5. The film according to claim 4, wherein the extension layer conformally covers on the first surface of the wood veneer layer.

6. The film according to claim 4, wherein the base layer is a non-woven fabric layer, and the non-woven fabric layer fills the second surface of the wood veneer layer to improve a flatness of the second surface.

7. The film according to claim 1, wherein the adhesive layer comprises a hot melt adhesive, a UV hardening adhesive, a light hardening adhesive, an electron hardening adhesive, or a combination thereof, and a material of the adhesive layer is at least one selected from the group consisting of polyacrylate, polymethacrylate, polystyrene, polycarbonate, polyurethane, polyester, polyamide, epoxy resin, ethylene vinylacetate copolymer, and thermoplastic elastomer.

8. The film according to claim 1, further comprising a pattern layer disposed on the extension layer, such that the extension layer is located between the pattern layer and the wood veneer layer.

9. A film for decorating a workpiece, comprising:
a wood veneer layer, having a first surface and a second surface opposite to each other;
an adhesive layer, disposed on the second surface of the wood veneer layer; and
a base layer, disposed between the wood veneer layer and the adhesive layer, wherein the adhesive layer is disposed between the base layer and the workpiece.

10. A decorated molding article, comprising:
a workpiece, having an outer surface; and
the film according to claim 1, disposed on the outer surface of the workpiece, wherein the film is attached on the workpiece by the adhesive layer.

11. The decorated molding article according to claim 10, wherein a material of the outer surface of the workpiece comprises a plastic, metal, a carbon fiber, glass, or a combination thereof.

12. A method for fabricating a decorated molding article, comprising:
providing the film according to claim 1;
performing an in-mold decoration or an out mold decoration on the film, such that the film is attached on an outer surface of the workpiece by the adhesive layer.

13. The method for fabricating the decorated molding article according to claim 12, wherein the step of performing the in-mold decoration on the film comprises:
disposing the film in an in-mold decoration mold having a mold cavity, wherein the film covers at least a portion of a surface of the mold cavity;
injecting a molding material into the in-mold decoration mold, such that the molding material and the film are combined with each other;
cooling the molding material; and
taking out the decorated molding article from the in-mold decoration mold.

14. The method for fabricating the decorated molding article according to claim 12, wherein the step of performing the out mold decoration on the film comprises:
providing a workpiece;
placing the workpiece and the film in a fixture; and
performing a high pressure decorative molding process, such that the film is attached on the outer surface of the workpiece by the adhesive layer.

15. The method for fabricating the decorated molding article according to claim 14, wherein the high pressure decorative molding process comprises:
performing a heating and softening step on the film;
contacting the film with the workpiece, and performing a pressing step; and
performing a high pressure vacuum molding step on the film and the workpiece, such that the film is attached on the outer surface of the workpiece.

16. The method for fabricating the decorated molding article according to claim 15, wherein a temperature of the heating and softening step is between 50° C. and 180° C.

17. The method for fabricating the decorated molding article according to claim 15, wherein a time of the heating and softening step is between 1 second and 300 seconds.

18. The method for fabricating the decorated molding article according to claim 12, wherein a method for forming the film comprises:
providing a wood veneer layer, the wood veneer layer having a first surface and a second surface opposite to each other;
forming a base layer on the second surface of the wood veneer layer;
forming an adhesive layer on the base layer, such that the base layer is disposed between the wood veneer layer and the adhesive layer.

19. The method for fabricating the decorated molding article according to claim 18, wherein the method for forming the film further comprises forming an extension layer on the first surface of the wood veneer layer, wherein a method for forming the extension layer comprises forming a resin material layer on the first surface of the wood veneer layer by a roll coating method, a spraying method, a printing method, or a coating method.

20. The method for fabricating the decorated molding article according to claim 19, wherein the method for forming the film further comprises forming a pattern layer on the extension layer, such that the extension layer is located between the pattern layer and the wood veneer layer.
